(19) United States
(12) Patent Application Publication
(10) Pub. No.: US 2011/0257906 A1
(43) Pub. Date: Oct. 20, 2011

(54) Method for processing a time discrete, one dimensional, measurement signal

(76) Inventor: Rémy Scherrer, Oberdorf (FR)

(21) Appl. No.: 13/085,807

(22) Filed: Apr. 13, 2011

(30) Foreign Application Priority Data
Apr. 14, 2010 (DE) 10 2010 003948.9

(51) Int. Cl. G06F 19/00; G01F 1/78

(52) U.S. Cl. 702/48; 702/190

(57) ABSTRACT

A method for processing a time discrete, one dimensional, measurement signal. The method includes the step of applying to the sequence a recursive filter having a variable recursion coefficient (K(n)), wherein the recursive filter is embodied in such a manner that, in each case, the output, measured value (y(n)) obtained for a measured value (x(n)) is obtainable by subtracting a preceding output, measured value (y(n−1)) from such measured value (x(n)), by multiplying the obtained difference value (d(n)) with a recursion coefficient (K(n)) associated with such measured value (x(n)) and by adding the obtained product to the preceding output, measured value (y(n−1)). For determining the recursion coefficient (K(n)) associated with a measured value (x(n)), a predetermined function (Kₗᵢₙ(da)) rising at least sectionally with the magnitude of the difference value (da) is applied to the magnitude (da(n)) of the difference value (d(n)) obtained for such measured value and the obtained function value (Kₗᵢₙ(n)) is applied recursion coefficient (K(n)) as corresponding to such measured value x(n), at least when the function value (Kₗᵢₙ(n)) is greater than or equal to the recursion coefficient associated with the preceding measured value (K(n−1)).

The present invention relates to a method for processing a time discrete, one dimensional, measurement signal in the form of a sequence of measured values following one after another in time.

The processing of measurement signals, for example, for evaluations, for control applications, for visual presentation, for purposes of documentation, etc., is performed increasingly digitally. In such case, the (time-dependent) measured value is, as a rule, first registered analogly by a sensor and an analog measurement signal is provided. In known manner, such an analog measurement signal can be converted, for example, by sampling of the same with a (high) sampling frequency, into a time discrete, one dimensional, measurement signal (in the following: “measurement signal”), which has a sequence of measured values following one after another in time. The measurement signal obtained thereby has fluctuations and, respectively, noise due to the, as a rule, high selected sampling frequency. In such case, it is known to filter the measurement signal via so-called decimation stages, which, in each case, form a low-pass filter, and to reduce the data rate. The higher the desired data rate of the (in given cases, decimated) measurement signal, the more strongly the measurement signal is, as a rule, burdened with noise. These fluctuations of the measured value can be disturbing, especially when the process variable represented by the measured value actually does not change or changes only slightly. Conversely, in the case of many applications, it is required that changes of the measurement signal, which do not represent noise and which are caused by a change of the underlying process variables, be registered as quickly as possible.

This problem exists in, among others, the area of process automation technology involving the use of field devices serving as sensors. Sensors serve for registering process variables. For example, fill level measuring devices, flow measuring devices, pressure- and temperature measuring devices, pH-redox potential measuring devices, conductivity measuring devices, etc., serve for registering the corresponding process variables, fill level, flow, e.g. flow rate, pressure, temperature, pH-value, and conductivity, respectively. In modern industrial plants, such sensors are, as a rule, connected via bus systems (Profibus@, Foundation® Fieldbus, HART®, etc.) with at least one superordinated unit. Superordinated units serve, in such case, especially for process control, process visualizing, process monitoring, etc.

In the case of time critical applications, it is required that the particular superordinated unit be informed, for example, for process control and/or process monitoring, as near as possible in time concerning changes occurring in the registered process variables. Accordingly, in the case of modern, digital control processes, increasingly, a high data rate and a high signal bandwidth of the provided measurement signal are required. A signal processing of the measurement signal (occurring, for example, in the field device), by which the occurring change of the registered process variables is returned only significantly delayed and/or flattened, is disadvantageous as regards these requirements. On the other side of the same subject, fluctuations of the measured value are disturbing, especially when no or only a slight change of the registered process variable occurs. This is true, among other things, for the purposes of visualizing the process. If, for example, the measured value registered by a field device is displayed on an on-site display of the field device, then an “unsteadiness” of the indicated measured value due to the arising fluctuations is disturbing.

The above explained requirements exist especially as regards the processing of a measurement signal processed in a flow measuring device. Such flow measuring devices, as, for example, Coriolis-flow measuring devices, are applied, in order to determine at least one parameter, such as, for example, a mass flow, a density and/or a viscosity, of a fluid flowing in a pipeline. In such case, it is for process control and/or process monitoring for many applications essential that a change occurring in the measurement signal brought about, for example, by a change of the mass flow is brought back as near as possible in time and correctly in the processed measurement signal, even when a digital signal processing for suppressing noise is performed.

It is, among other things, known to use recursive filter for processing a video signal. In such case, a recursive filtering is applied especially in such picture regions, which, over a number of image sequences, remain unchanged (static pictures with accordingly redundant image information).

Accordingly, an object of the present invention is to provide a method for processing a time discrete, one dimensional, measurement signal in the form of a sequence of measured values following one after another in time. The method should suppress noise in the measurement signal effectively and return, as near as possible in time and correctly in the processed measurement signal, simultaneously occurring changes of the measurement signal, which extend above the noise level.

The object is achieved by a method as claimed in claim 1 as well as by a Coriolis-flow measuring device as claimed in claim 12. Advantageous further developments of the invention are set forth in the dependent claims.

The present invention provides a method for processing a time discrete, one dimensional, measurement signal in the form of a sequence of measured values following one after another in time. The method includes, in such case, a step in which a recursive filter having a variable recursion coefficient is applied to the sequence. The recursive filter is embodied, in such case, in such a manner that, in each case, the output, measured value obtained for a measured value is obtainable by subtracting a preceding output, measured value from such measured value, by multiplying the obtained difference value by a recursion coefficient associated with such measured value and by adding the obtained product to the preceding output, measured value. In such case, in each case, for determining the recursion coefficient associated with a measured value, a predetermined function rising, at least in a section, with the magnitude of the difference value is applied to the magnitude of the difference value obtained for such measured value. The function value obtained in such case is applied as the recursion coefficient corresponding to such measured value at least when the (obtained) function value is greater than or equal to the recursion coefficient associated with the preceding measured value.

In order that the recursion coefficient be variable, according to the present invention, a filtering can, in each case, be matched to the curve of the measurement signal. Since the function rises at least sectionally with the magnitude of the difference values, there result for higher magnitudes of the difference values, i.e. for bigger changes of the measurement signal, correspondingly also bigger function values. The greater the recursion coefficient is, the smaller is the filtering, or smoothing, of the measurement signal by the recursive filter. Accordingly, there occurs in the case of high magnitudes of the difference values no or only a low filtering and occurring changes in the measurement signal can be returned near in time and correctly in the processed measurement signal. Conversely, there result in the case of lower magnitudes of the difference values also correspondingly lower function values. The lower the recursion coefficient, the more strongly is the filtering, or smoothing, of the measurement signal by the recursive filter. Accordingly, in cases, in which the measurement signal does not change or changes only slightly, the noise can be effectively suppressed. Additionally, in this way, measurement signal changes, which have an amplitude beyond the expected noise level and which can occur over a comparatively broad frequency bandwidth, can be returned near in time and correctly in the processed measurement signal. Accordingly, the method of the invention can provided a high data rate of the processed measurement signal with a relatively high frequency bandwidth, wherein, simultaneously, disturbing fluctuations in the measurement signal are largely suppressed.

Since the obtained function value is applied as recursion coefficient corresponding to such measured value, at least when the function value is greater than or equal to the recursion coefficient associated with the preceding measured value, in the cases, in which the measurement signal strongly changes, a relatively rapid increasing (according to the function) of the recursion coefficient is enabled. In this way, in these cases, the filtering, or smoothing, of the measurement signal is reduced and the processed measurement signal can rapidly follow the change. Fundamentally, the function value can also be applied as recursion coefficient corresponding to such measured value, when the function value is less than the recursion coefficient associated with the preceding measured value. Alternatively, as explained below in reference to further developments, also a slower fall off of the recursion coefficient than predetermined by the function, can be implemented. In latter case, it is enabled that when the measurement signal, after a change, sets to a changed level, which means that the difference values and, accordingly, the function values reduce, also the processed measurement signal rapidly tunes to this changed level.

The terminology “one dimensional” measurement signal means that the measured values of the sequence represented one and the same physical variable, such as, for example, oscillation amplitude, phase difference, etc., at different points in time. The individual measured values of the sequence have, in such case, preferably, in each case, a constant time difference to one another. The “measured values” can especially be measured values directly registered by a sensor, measured values already further processed and/or measured values combined with measured values of another measurement signal. In given cases, the measured values can be quantized, in order that they can be digitally processed. The recursive filter has especially a DC amplification of one. This means that no amplification of the measurement signal occurs in the processing with the recursive filter. The terminology “recursion coefficient corresponding to a measured value” means, especially, a recursion coefficient determined specifically for such measured value, which then is applied to this measured value. The terminology “preceding output, measured value” means the output, measured value obtained for the preceding measured value. To the extent that in connection with the recursive filter reference is to a “preceding” variable (e.g. measured value, output, measured value, recursion coefficient, etc.), especially reference is to the directly preceding variable (i.e., for example, to the directly preceding measured value of the sequence; or generally to variable corresponding to the therein directly preceding cycle of the recursive filter) taken. In this case, it would be a recursive filter of first order. In general, however, the “preceding” variable can also be spaced continuously back by more than one, for example, by two or three.

Additionally, it is said that the output, measured value obtained by applying the recursive filter to a measured value “is obtainable”. This means that exactly the set forth steps can be performed in applying the recursive filter or also alternative steps, which likewise fulfill the given mathematical relationship.

According to the invention, the function rises at least sectionally (i.e. at least over a determined range of the magnitude of the difference value), i.e. It has in this range a slope greater than zero. Preferably, the function has in the value range of the magnitude of the difference value in question continuously a slope of greater than or equal to zero. The function can, in such case, also have sections, in which the slope is zero.

In a further development, the function has a step in such a manner that it rises more strongly from a first limit value of the magnitude of the difference value than in the region before the first limit value. In this way, it can be implemented that for values of the magnitude of the difference value, which are less than the first limit value, a relatively strong (and constant or largely constant) filtering is performed. For, in this range, the function values are relatively small. If the magnitude of the difference value exceeds the first limit value, then the function values are significantly greater, which leads thereto that in this range the filtering, or smoothing, is correspondingly reduced. Accordingly, this further development enables the limit value to be so chosen as a function of the to expected noise level that, for difference values, which lie within the noise region, a relatively strong filtering, or smoothing, is performed and that in the case of difference values, which beyond the noise region go, no or only a clearly reduced, filtering, or smoothing, is performed. This further development is, thus, especially advantageous when the expected noise level can be well determined and, thus, by a corresponding determining of the first limit value and of the curve of the function, the filtering, or smoothing, then is matched in use flexibly as a function of the actually arising difference values. Especially, according to a further development, it is provided that the slope of the function in the region before the first limit value is zero. In general, the change of the slope at the first limit value can occur continuously or discontinuously. In a further development, it is provided that the function rises linearly after the first limit value.

In a further development, the slope of the function from a second limit value of the magnitude of the difference value, which is greater than the first limit value, is reduced relative to the slope in the region before the second limit value. In this way, it can be implemented that, for values of the magnitude of the difference value, which are greater than the second limit value, no or only a very low filtering is performed. For values of the magnitude of the difference value between the first and the second limit values, the filtering decreases continuously with increasing magnitude of the difference values, due to the rising the function in this region. Accordingly, the first and the second limit values, the slope in the region between the two limit values as well as the slope in the region from the second limit value of the function can be determined suitably for an expected noise level. As already explained above, also this further development is especially advantageous when the expected noise level can be well determined and accordingly the second limit value and the curve of the function before and after the second limit value can be suitably determined. In general, the change of the slope at the second limit value can occur continuously or discontinuously. The second limit value can also be arranged directly bordering the first limit value, so that the function between the first and the second limit value rises completely or sectionally perpendicularly.

In a further development, in each case, for determining the recursion coefficient associated with a measured value, when the function value obtained in reference to such measured value is less than the recursion coefficient associated with the preceding measured value, the recursion coefficient associated with such measured value is determined according to a predetermined algorithm in such a manner that it is greater than the function value and less than or equal to the recursion coefficient associated with the preceding measured value. By this further development, there is implemented a slower fall off of the recursion coefficient from a higher to a lower value, than that determined by the function. This enables that especially when the measurement signal after a greater change settles at a changed level, which means that the difference values and accordingly the function values get smaller, also the processed measurement signal (due to the furthermore relatively high associated recursion coefficient) tunes rapidly to this changed level. Preferably, the algorithm as regards stability of the filter is embodied in such a manner that, to the extent that the condition for the application of the algorithm is fulfilled, the associated recursion coefficient determined according to the algorithm is less than the recursion coefficient associated with the preceding measured value.

In a further development, the predetermined algorithm is embodied in such a manner that the recursion coefficient associated with such measured value is obtainable by subtracting the function value from the recursion coefficient associated with the preceding measured value, by multiplying the obtained recursion coefficient difference values by a tuning factor and by adding the obtained recursion coefficient product to the function value. Since it is given that the recursion coefficient associated with such measured value “is obtainable” by the set forth steps, this includes that exactly the set forth steps, or also alternative steps, which likewise fulfill the given mathematical relationship, can be performed in the case of applying the recursive filter. The tuning factor is, in such case, especially constant throughout the different cycles of the recursive filter. Additionally, it can be provided that the value of the tuning factor is adjustable. In this way, a user can choose a tuning factor as a function of the relevant application.

In a further development, the tuning factor is greater than zero and less than or equal to one. Especially, it can lie in the range between 0.7 and 1. In reference to a stability of the filter, it is advantageous when the tuning factor is less than one. A well suitable region is, for example, a region of 0.80 to 0.95.

In a further development, the function values of the function in the region before the first limit value are constant and greater than zero, especially constant and at least 64/8192. The maximum filter strength, or smoothing, is determined by this constant value. By providing constant function values in this range in the cases, in which the magnitude of the difference value is less than the first limit value, a relatively strong and constant filtering is performed. In the case of values of the recursion coefficient of less than 0.01, especially, a relatively strong filtering, or smoothing, is achieved, which is desirable for many applications. The (preferably provided) minimum value of 64/8192 (corresponding to 2⁶/2¹³) is advantageous as regards the stability of the filter.

In a further development, the function values of the function in the region after the second limit value are constant and greater than the function values in the region before the first limit value. Especially, they are constant and one. By providing constant function values in this range, in the cases, in which the magnitude of the difference value is greater than the second limit value, a relatively weak and constant filtering is performed. If the function values in this range are equal to one, then filtering, or smoothing, is no longer performed and the measured values are (slightly time delayed) unchanged by the filter output.

In a further development, the distance between the first and the second limit value lies in the range of 0.2 to 0.3 times the first limit value. This range of the distance—i.e. of the window, in which the function value rises more strongly—has been found experimentally to be quite suitable. Especially, good results were achieved in the case of a distance of 0.25 times the first limit value.

In a further development, the method is performed on a measurement signal processed (or provided) in a flow measuring device, in which at least one parameter (e.g. volume flow, mass flow, density, viscosity, etc.) of a fluid flowing in a pipeline is determinable. The measured values of this measurement signal can be especially measured values directly registered by a sensor of the flow measuring device, already further processed measured values and/or measured values combined with measured values of another measurement signal (which was, for example, registered by an additional sensor of the flow measuring device). In a further development, the measurement signal is a phase difference, measurement signal processed (or provided) in a Coriolis, flow measuring device, wherein the phase difference, measurement signal represents the phase difference of the oscillation of at least one measuring tube between two measurement points on the measuring tube spaced from one another along the flow direction. The application of the method of the invention in the case of flow measuring devices and especially in the case of Coriolis, flow measuring devices is especially advantageous, since in the case of these devices the expected noise level is well determinable and accordingly a corresponding matching of the filter strength as a function of the respective difference value can be performed very well. In the case of Coriolis, flow measuring devices, there exist a plurality of different types, which can differ especially in the number and geometry of the measuring tubes, the arrangement and number of sensors, the exciting of the at least one measuring tube to execute oscillations, etc., wherein the method of the invention is put into practice independently of the particular type.

The present invention relates additionally to a Coriolis, flow measuring device, which is insertable into a pipeline and by which a mass flow of a fluid flowing in the pipeline is determinable. The Coriolis, flow measuring device includes, in such case, at least one measuring tube for conveying the fluid flowing in the pipeline, at least one exciter, by which the at least one measuring tube is excitable to execute mechanical oscillations, and two sensors arranged on the measuring tube and spaced from one another along the flow direction for registering mechanical oscillations of the measuring tube. An electronics of the Coriolis, flow measuring device is, in such case, embodied in such a manner that the electronics produces from the sensor-measurement signals produced by the two sensors a time discrete, one dimensional, measurement signal representing the phase difference of the oscillation of the measuring tube between the two measurement points of the sensors and having a sequence of measured values following one after another in time. Additionally, the electronics can apply to the sequence a recursive filter having a variable recursion coefficient, wherein the recursive filter is embodied in such a manner, that, in each case, the output, measured value obtained for a measured value is obtainable by subtracting a preceding output, measured value from such measured value, by multiplying the obtained difference value by a recursion coefficient associated with such measured value and by adding the obtained product to the preceding output, measured value. Additionally, for determining the recursion coefficient associated with a measured value, the electronics provides, in each case, for applying to the magnitude of the difference value obtained for such measured value a predetermined function rising, at least sectionally, with the magnitude of the difference value, and the obtained function value is applied as recursion coefficient corresponding to such measured value, at least when the function value is greater than or equal to the recursion coefficient associated with the preceding measured value.

In the case of the Coriolis flow measuring device of the invention, the advantages explained above in reference on the method of the invention are achieved in corresponding manner. Additionally, the above explained further developments are options in corresponding manner, wherein, in the case of method steps, the electronics is embodied in such a manner that these method steps are performable by the electronics.

As is explained above, also in the case of the Coriolis-flow measuring device of the invention, different types are possible. Especially, the Coriolis, flow measuring device can also have more than one measuring tube and more than the above mentioned, two sensors. The electronics of the Coriolis, flow measuring device can be formed by hardware and/or software of the Coriolis, flow measuring device. It can additionally be divided into a number of units.

Other advantages and utilities of the invention will become evident based on the following description of forms of embodiment as understood with reference to the appended drawing, the figures of which show as follows:

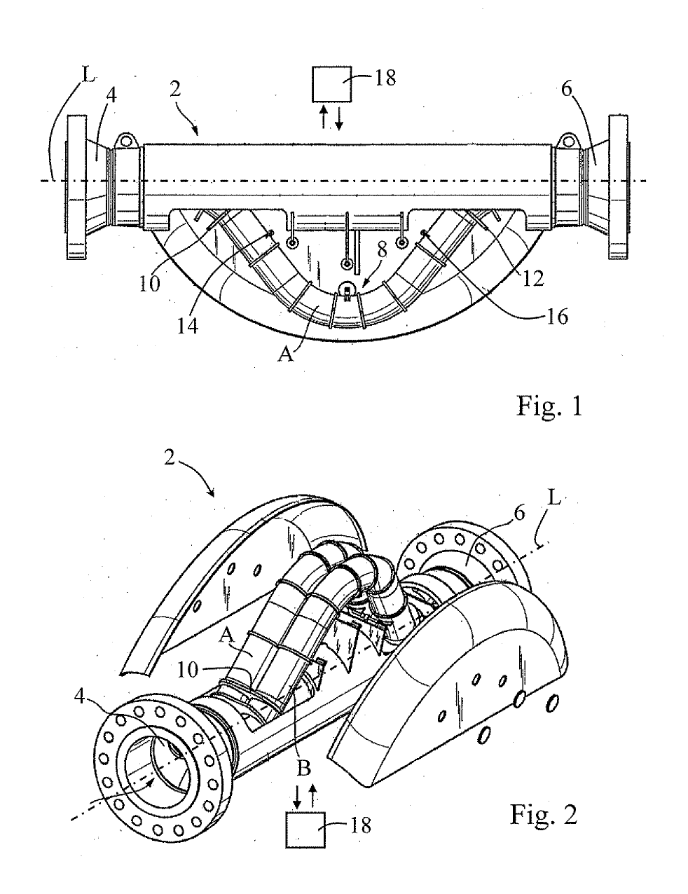

FIG. 1 by way of example, a side view of a Coriolis, flow measuring device having two measuring tubes, with the housing of the device being partially removed;

FIG. 2 the Coriolis, flow measuring device of FIG. 1 in perspective view with partially removed housing;

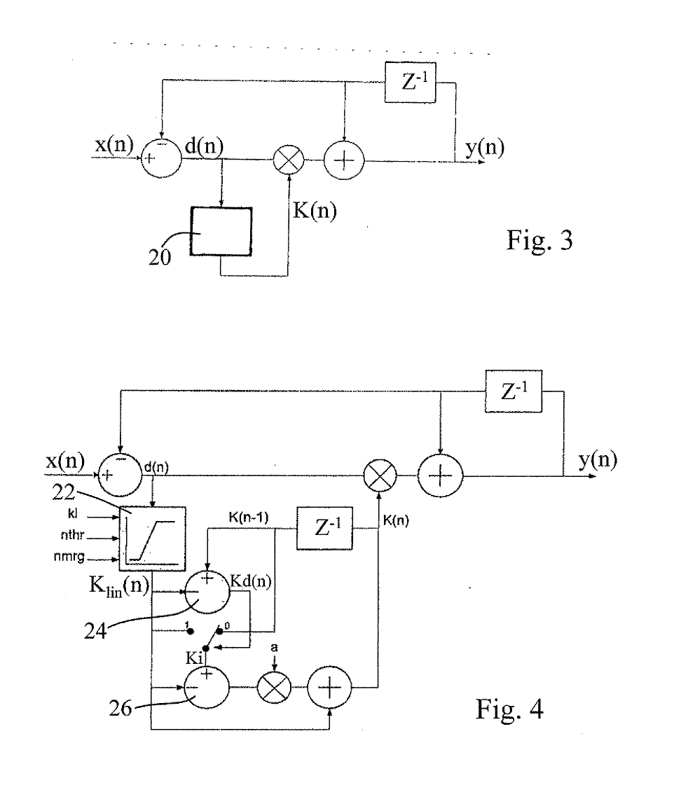

FIG. 3 a schematic representation of a recursive filter of first order for illustrating a form of embodiment of the present invention;

FIG. 4 a schematic representation of the recursive filter of FIG. 3, wherein a form of embodiment for determining the variable recursion coefficient is presented in detail;

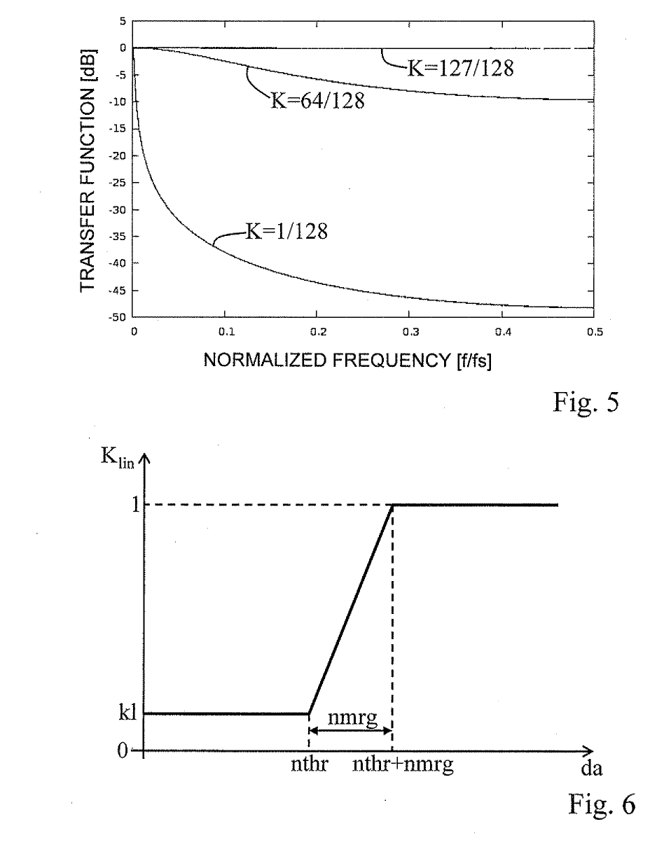

FIG. 5 a schematic representation of the transfer function of the filter illustrated in FIG. 3 for different values of the variable recursion coefficient;

FIG. 6 a schematic representation of the function according to a form of embodiment for determining the variable recursion coefficient;

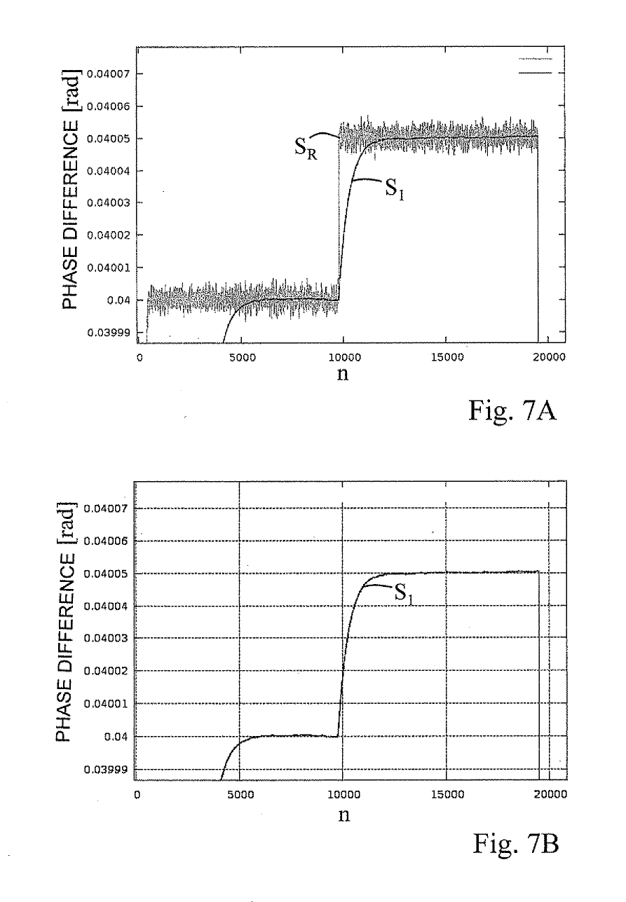

FIG. 7A a graphical representation of a phase difference, measurement signal and of the measurement signal processed with a recursive filter having a constant recursion coefficient;

FIG. 7B a graphical representation of the processed measurement signal illustrated in FIG. 7A;

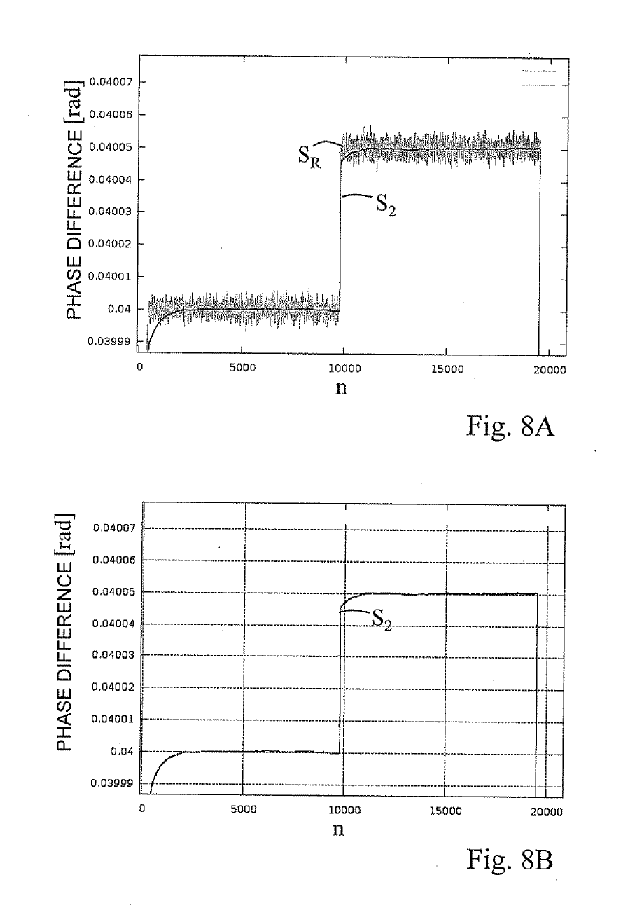

FIG. 8A a graphical representation of the phase difference, measurement signal of FIG. 7A and of the measurement signal processed with a recursive filter according to a form of embodiment of the invention;

FIG. 8B a graphical representation of the processed measurement signal illustrated in FIG. 8A;

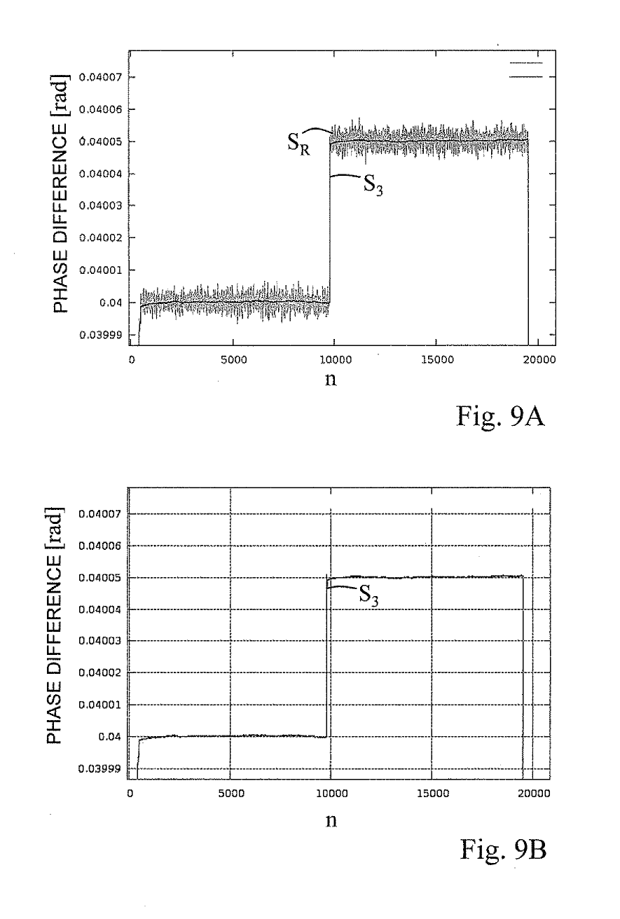

FIG. 9A a graphical representation of the phase difference, measurement signal of FIG. 7A and of the measurement signal processed with a recursive filter according to an additional form of embodiment of the invention;

FIG. 9B a graphical representation of the processed measurement signal illustrated in FIG. 9A;

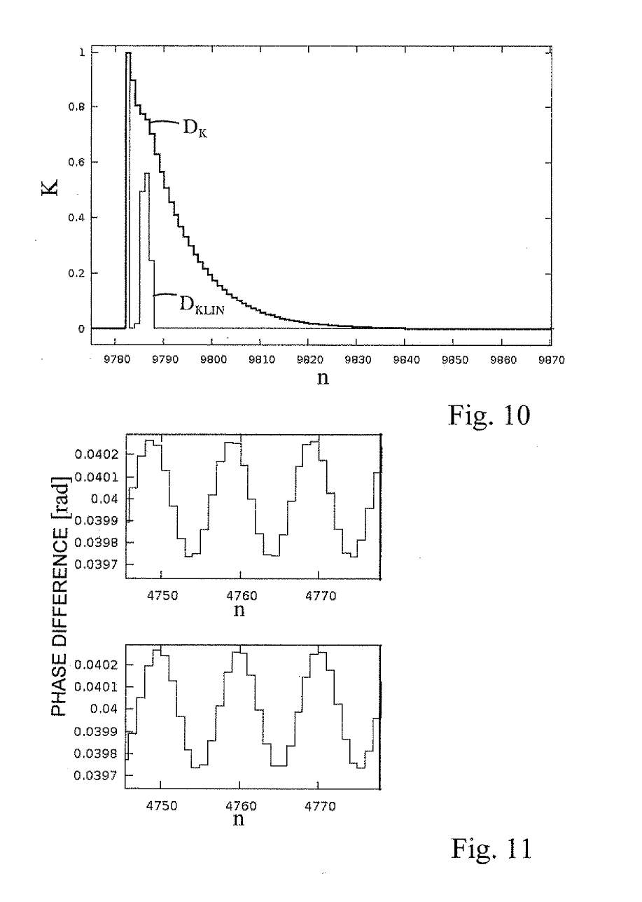

FIG. 10a graphical representation of the development of the value for the recursion coefficient in the case of the form of embodiment illustrated in FIGS. 9A and 9B; and

FIG. 11a graphical representation of an additional phase difference, measurement signal and of the measurement signal processed with a recursive filter according to a form of embodiment of the invention.

FIGS. 1 and 2 show, by way of example, a Coriolis, flow measuring device 2 embodied according to the present invention. Especially, the method of the invention is performable by this Coriolis, flow measuring device 2. The Coriolis, flow measuring device 2 includes two oscillatably held, measuring tubes A and B, each of which is curved and extends parallel to the other. The Coriolis, flow measuring device 2 is, in such case, insertable in such a manner into a pipeline (not shown) that the two measuring tubes A and B fluid flowing in the pipeline flows through the two measuring tubes A and B. Flow dividers 4, 6 are provided on the input and output ends of the measuring tubes A and B.

Extending between the two measuring tubes A and B is an exciter 8. Exciter 8 in the case of the present form of embodiment is arranged at the peaks of the arcs of the two measuring tubes A and B. The exciter 8 periodically pushes apart and/or draws together the two measuring tubes A and B, so that they execute bending oscillations. In such case, the two measuring tubes A and B are excited with opposite phase to one another and trace, in each case, a swinging movement about a longitudinal axis L of the Coriolis, flow measuring device 2. The two measuring tubes A and B are additionally mechanically coupled to one another on the input side and the output side by corresponding coupling elements 10, 12.

Between the two measuring tubes A and B, in each case, on an inlet side and on an outlet side section of such, extend two oscillation sensors 14, 16. In the present form of embodiment, the two oscillation sensors 14, 16 register, in each case, the separation change between the two measuring tubes A, B, i.e. their combined amplitude. The oscillation sensors 14, 16 output as a function of the oscillations the measuring tubes A and B, in each case, a sensor voltage. In such case, each of these voltages is an analog measurement signal. The exciting of the exciter 8 by applying a corresponding excitation voltage as well as the processing and evaluation of the analog measurement signals provided by the oscillation sensors 14, 16 occurs by a correspondingly embodied electronics 18, which is presented only schematically by a box in FIGS. 1 and 2.

A variable essential for the evaluation is, in such case, the (time-dependent) phase difference Δφ (tᵢ) of the oscillation of the two measuring tubes A, B between the two measurement points formed by the oscillation sensors 14, 16. From this phase difference Δφ(tᵢ), as is known to those skilled in the art, especially the mass flow of the fluid flowing in the pipeline can be determined.

For determining the phase difference Δφ(tᵢ), the electronics 18 utilizes the two analog measurement signals provided by the oscillation sensors 14, 16, in each case, to determined the phase information φ₁(tᵢ), φ₂(tᵢ) of the oscillation of the two measuring tubes A, B at the measurement points formed by the two oscillation sensors 14, 16. For this, especially the analog measurement signal provided by the oscillation sensors 14, 16, in each case, formed, as a rule, by a sensor voltage corresponding to the oscillations is sampled with a high sampling frequency, such as, for example, 40 kHz (kilohertz). In this way, a time discrete, one dimensional, measurement signal in the form of a sequence of measured values following one after another in time is obtained. As a rule, the individual measured values of the sequence are also quantized, in order to enable digital processing. Additionally, each measurement signal, in the case of the present form of embodiment, is converted into an analytical signal, composed of a real part R(tᵢ) and an imaginary part I(tᵢ). For this, for example, in known manner two filters, which have a phase difference of 90°, can be applied in parallel. Furthermore, it is, in the case of the present form of embodiment, provided that the data rate of the analytical signal is reduced. This can occur, for example, via corresponding decimation stages. From the analytical signal, as is known to those skilled in the art, in each case, (time-dependent) amplitude information A₁(tᵢ), A₂(tᵢ) as well as (time-dependent) phase information φ₁(tᵢ), φ₂(tᵢ) of the oscillation of the two measuring tubes A, B at the respective measuring points can be obtained. The phase difference Δφ(tᵢ) between the two measurement points formed by the oscillation sensors 14, 16 can be obtained by forming the difference of the phase information φ₁(tᵢ), φ₂(tᵢ) of the oscillations registered by the two oscillation sensors 14, 16. Since in the case of the present form of embodiment, the signal processing occurs largely digital, the respective processed measuring signals are time discrete, so that, in each case, reference is taken to particular points tᵢ in time.

The electronics, as a rule, evaluates the amplitude information A₁(tᵢ), A₂(tᵢ) as well as the phase information φ₁(tᵢ), φ₂(tᵢ). Especially, as a function of these variables, in each case, the exciting of the measuring tubes A, B by the exciter 8 exciting the controlled. From the phase difference Δφ (tᵢ), additionally, the mass flow of the fluid flowing in the pipeline can be determined.

The phase difference Δφ(tᵢ) is processed, and, respectively, provided in the Coriolis, flow measuring device 2, in such case, as a time discrete, one dimensional, measurement signal, which has a sequence of measured values following one after another in time (here: phase difference values). In the present form of embodiment, the method of the invention is applied to this phase difference, measurement signal Δφ(tᵢ). The phase difference, measurement signal Δφ(tᵢ), to which the method of the invention is applied, can be obtained, in such case, in the above explained manner. However, also other digital or analog signal processings, such as, for example, an amplification, a zero-point-compensation, etc., can be performed, in order to provide the phase difference, measurement signal Δφ(tᵢ). By the method of the invention, it is achieved that in the regions, in which the actual phase difference does not change or changes only slightly, noise effectively is suppressed. Conversely, when a change in the actual phase difference occurs, which in the phase difference, measurement signal Δφ(tᵢ) is greater than the expected noise level, the filtering is strongly or completely reduced, so that this change is returned near in time and correctly in the processed measurement signal. In this way, especially in the mass flow, measured value provided by the Coriolis, flow measuring device 2, undesired fluctuations are suppressed and simultaneously, occurring changes are returned near in time and correctly.

Additionally, it can also be provided that other or further, one dimensional, time discrete measuring signals processed, and, respectively, provided, in the Coriolis, flow measuring device 2 are processed according to the method of the invention. As explained below in reference to the additional FIGS., the method of the invention is suited especially for application to a measurement signal (especially a phase difference, measurement signal Δφ(tᵢ)) processed, and, respectively, provided, in a Coriolis, flow measuring device, since in Coriolis, flow measuring devices the expected noise level in the case of the respective measurement signal can be estimated quite well. Accordingly, it can be estimated quite well, after which changes in the measurement signal actually also a change in the process variables to be registered (here: fluid parameters) should occur and accordingly a filtering should be reduced or completely suppressed. Also, in the case of other types of flow measuring devices, by which at least one parameter (e.g. volume flow, mass flow, density, viscosity, etc.) of a fluid flowing in a pipeline is registerable, the expected noise level in the respective measurement signal can frequently be estimated quite well. Accordingly, the method of the invention is also generally well suited for application to a measurement signal processed, and, respectively, provided, in a flow measuring device. Also in fields of application outside flow measurement, the method of the invention is advantageous. Especially good results can particularly be achieved when the expected noise level can be estimated quite well.

Accordingly, there will now be explained with reference to the figures generally a form of embodiment of the method of the invention applied to a time discrete, one dimensional, measurement signal (in the following: “measurement signal”), which has a sequence of measured values following one after another in time x(n). As has been explained above, this measurement signal can especially be formed by the above explained, phase difference, measurement signal Δφ(tᵢ). The results of the application of the method of the invention to two explained forms of embodiment on a phase difference, measurement signal are then likewise explained with reference to the figures.

FIG. 3 shows the operation in principle of a recursive filter of first order. The recursive filter has according to the present form of embodiment a DC amplification of one. In such case, FIG. 3 shows the situation in which the recursive filter is applied to a measured value x(n) of the sequence and outputs for such measured value x(n) the output, measured value y(n). First, the output, measured value y(n−1) (in the following: “directly preceding output, measured value”) obtained for the directly preceding measured value x(n−1) of the sequence is subtracted from the measured value x(n), in order to obtain the difference value d(n). Then, a recursion coefficient K(n) corresponding to the measured value x(n) is determined. Considered in this determining is, among other things, the obtained difference value d(n). The determining of the associated recursion coefficient is indicated schematically in FIG. 3 by the box 20 and is explained below in greater detail according to a form of embodiment. The recursion coefficient K(n) associated with the measured value x(n) is then multiplied with the obtained difference value d(n). To the obtained product value is then added the directly preceding output, measured value y(n−1). The underlying mathematical relationship is shown in the following equation (1):

y(n)=(x(n)−y(n−1))*K(n)+y(n−1)=d(n)*K(n)+y(n−1) (1)

In FIGS. 3 and 4, Z represents the Z-transformation. As known to those skilled in the art, Z⁻¹ means, in such case, a delay by one sample value, or, generally, one value of the sequence, occurs.

The filter characteristic curve of the recursive filter is, in such case, dependent on the value of the recursion coefficient. While in the case of a value of the recursion coefficient of 1, no filtering takes place and the measured value is output unchanged by the recursive filter, when the value of the recursion coefficient is approximately 0, there is a strong filtering and therewith a strong reduction of the bandwidth (i.e. a reduction of the frequency range of the processed measurement signal). This relationship is also evident based on FIG. 5, in which the transfer function of the filter in the frequency domain for values K of the recursion coefficient of K=127/128, of K=64/128 and of K=1/128 is shown. In such case, in FIG. 5 the y-axis is scaled in decibel, while along the x-axis the frequency f is plotted normalized with the data rate fs of the measurement signal.

The representation in FIG. 4 corresponds to essentially to the representation in FIG. 3, except that, in FIG. 4, a method (according to a form of embodiment of the invention) for determining the associated recursion coefficient K(n) is shown in detail in place of the box 20 (in FIG. 3). For determining the associated recursion coefficient, a function Kₗᵢₙ(da), which rises with the magnitude “da” of the difference value, is taken into consideration. This function Kₗᵢₙ(da) is schematically shown in FIG. 6. Up to a first limit value nthr, the function Kₗᵢₙ(da) has a slope of zero and the constant value kl. In the case of the present form of embodiment, for kl, a value of 64/8192 (corresponds to 2⁶/2¹³) was selected (the size relationships are not correct in FIG. 6 returned). From the first limit value nthr, the function Kₗᵢₙ(da) rises linearly, until it reaches in the case of a second limit value nthr+nmrg the value 1 (or, generally, a maximum value for the recursion coefficient). From the second limit value nthr+nmrg, the function Kₗᵢₙ(da) has a slope of zero and the constant value 1. The distance between the first and the second limit value is given by the variable nmrg.

As based on the schematic representation in FIG. 6, it is evident that the function Kₗᵢₙ(da) forms a step. If the function Kₗᵢₙ(da) is used for determining the associated recursion coefficient K(n), then, based on FIG. 6, it is evident that, for values, of the magnitude da(n) of the difference value, which are less than the first limit value nthr, a strong filtering and therewith a strong reduction of the bandwidth occurs. In the case of values of the magnitude da(n) of the difference value, which are greater than the first limit value nthr, then the strength of the filtering continuously decreases, until, in the case of values of the magnitude da(n) of the difference value, which are greater than the second limit value nthr+nmrg, no more filtering, or smoothing, of the measurement signal occurs. This means that then the output, measured value y(n) equals the respective measured value x(n).

The application of a function Kₗᵢₙ(da), which essentially has the above described step shaped curve (wherein the respective values are to be matched to the corresponding application), is suited especially for applications, in the case of which the expected noise level can be well determined. This is especially true in the case of the measurement signals processed (or provided) in a Coriolis, flow measuring device, such as, for example, in the case of the phase difference, measurement signal. For, in the case of such devices, the signal- to noise ratio can be quite well estimated. The installed oscillation sensors deliver, as a rule, a very good (and known) signal- to noise ratio in the analog measurement signal. Added noise, which the measurement signal acquires due to the analog to digital conversion as well as due to the additional (especially digital), signal processing steps, such as, for example, the decimation steps, can be quite well determined. Accordingly, a suitable value for the first limit value of the function Kₗᵢₙ(da) can be quite well determined. In the present form of embodiment, the distance between the first limit value nthr and the second limit value nthr+nmrg was selected to be ¼ of the first limit value nthr.

The curve of the function illustrated in FIG. 6 can be described by the following equations (2)-(4). If, instead of 1, another maximum function value of the function after the second limit value nthr+nmrg is used, then, in equations (3) and (4), in each case, this maximum function value is to be used instead of the “1”.

in case da<nthr:Kₗᵢₙ(da)=kl (2)

in case da≧nthr and da<nthr+nmrg: (3)

$${K}_{lin} ( da ) = kl + \frac{( da - nthr ) * ( 1 - kl )}{nmrg}$$

in case da≧nthr+nmrg:Kₗᵢₙ(da)=1 (4)

Application of the function Kₗᵢₙ(da) to the magnitude da(n) of the obtained difference value d(n) is shown schematically in FIG. 4 by the box 22, in which the step shaped curve of the function Kₗᵢₙ(da) is indicated. Application of this function yields the function value Kₗᵢₙ(n) (more precisely, Kₗᵢₙ(da(n))). This function value Kₗᵢₙ(n) is in the following subtraction step 24 subtracted from the recursion coefficient K(n−1) associated with the preceding measured value x(n−1) and the value Kd(n) obtained. This relationship is shown in the following equation (5):

Kd(n)=K(n−1)−Kₗᵢₙ(n) (5)

In the following subtraction step 26, as a function of the sign of Kd(n), either the recursion coefficient K(n−1) associated with the preceding measured value x(n−1) or the function value Kₗᵢₙ(n) is fed to the positive input of such. Especially, when Kd(n) is greater than zero, the recursion coefficient K(n−1) associated with the preceding measured value x(n−1) is fed to the positive input. This corresponds to the case, in which the recursion coefficient would in the application of the function Kₗᵢₙ(da) develop toward a smaller value and therewith toward a higher filter strength, or smoothing. If, in contrast, Kd(n) is less than or equal to zero, then the function value Kₗᵢₙ(n) is fed to the positive input of the subtraction step 26. This relationship is shown in the following equations (6) and (7), wherein the value supplied to the positive input of the subtraction step 26 is referred to as Ki.

In case Kd(n)>0:Ki=K(n−1) (6)

In case Kd(n)≦0:Ki=Kₗᵢₙ(n) (7)

As evident from FIG. 4, Kₗᵢₙ(n) is additionally fed to the negative input of the subtraction step 26. Accordingly, in the subtraction step 26 Kₗᵢₙ(n) is subtracted from Ki and the obtained value (recursion coefficient difference value) multiplied, or weighted, with the tuning factor a. For a, a value is selected just under 1, especially a value of 0.95, in the case of the present form of embodiment. Then, to the obtained value (recursion coefficient-product value) there is added the function value Kₗᵢₙ(n). This relationship is shown in the following equation (8):

K(n)=(Ki−Kₗᵢₙ(n))*a+Kₗᵢₙ(n) (8)

As was explained above in reference to FIG. 3, the recursion coefficient K(n) associated with the measured value x(n) is then multiplied with the difference value d(n). To the obtained product value is then added the directly preceding output, measured value y(n−1).

On the basis of the equations (5) to (8), it is evident that, when the function value Kₗᵢₙ(n) is greater than or equal to the recursion coefficient K(n−1) associated with the preceding measured value x(n−1), the function value Kₗᵢₙ(n) is used as the recursion coefficient corresponding to the measured value x(n). In this way, a relatively rapid increasing of the recursion coefficient is enabled when the difference values increase. Accordingly, as explained above, in this case, the filter strength, or the smoothing, of the recursive filter is reduced.

If the function value Kₗᵢₙ(n) is less than the recursion coefficient K(n−1) associated with the preceding measured value x(n−1), then the recursion coefficient K(n) associated with such measured value x(n) is obtained by subtracting the function value Kₗᵢₙ(n) from the recursion coefficient associated with the preceding measured value K(n−1), by multiplying the obtained recursion coefficient difference values with the tuning factor a and by adding the obtained recursion coefficient product to the function value Kₗᵢₙ(n). In this way, the recursion coefficient K(n) associated with the measured value x(n) is determined in such a manner that it is greater than the function value Kₗᵢₙ(n) and less than the recursion coefficient associated with the preceding measured value K(n−1). In this way, it is achieved that, when the difference values lessen and, accordingly, in applying the function Kₗᵢₙ(da), comparatively low recursion coefficient would result, the recursion coefficient falls more slowly than would occur in the case of applying the function. As already explained above, it is thereby achieved that after a change of the measurement signal also the processed measurement signal adjusts rapidly to the changed value.

Different forms of embodiment of the present invention will now be explained, by way of example, based on a phase difference, measurement signal. For this, FIGS. 7A, 8A and 9A show, in each case, a phase difference, measurement signal of a Coriolis, flow measuring device still not processed according to the method of the invention and forming a time discrete, one dimensional, measurement signal. These phase difference, measurement signal will be referred to as unprocessed measurement signals S_{R}. Plotted along the x-axis is, in such case, sample value number, or, generally, measured value number of the sequence and along the y-axis the phase difference (unit: rad, or radians). As evident based on the representation in FIG. 7A, the phase difference changes (due to a change of the mass flow in the relevant pipeline) with a step shape. The unprocessed measurement signal S_{R} includes, in such case, significant noise, which is clearly visible especially in the regions, in which no change of the actual measured value occurs.

The processed measurement signal S₁ shown in FIGS. 7A and 7B was processed only with a recursive filter of first order, as it is shown in FIG. 3, with a constant value for the recursion coefficient K. In this case, a value of 64/8192 was applied for K. The result is that the processed measurement signal S₁ shows a change in the (unprocessed) measurement signal with considerable time delay. This result is comparable with an averaging method (MTA-filter: Mean Time Average-filter; time averaging filter) performed in previous Coriolis, flow measuring devices, in the case of which, in each case, a predetermined number of neighboring measured values are averaged for determining an output, measured value for a measured value.

FIG. 8A shows, again, the unprocessed measurement signal S_{R} shown in FIG. 7A. The processed measurement signal S₂ shown in FIGS. 8A and 8B was processed with a recursive filter of first order as shown in FIG. 3. In such case, for determining the recursion coefficient associated with the respective measured values, the function Kₗᵢₙ(da) was applied (for example, with the above explained parameters). Function Kₗᵢₙ(da) was explained with reference to FIGS. 4 and 6. Function Kₗᵢₙ(da) was applied for each measured value, independently of whether the function value obtained for a measured value was greater or less than the recursion coefficient associated with the preceding measured value. As evident from FIGS. 8A and 8B, this form of embodiment of the method of the invention clearly leads to better results. Especially, the processed measurement signal S₂ rapidly follows the occurring change in the measurement signal S_{R}. Solely in the region, in which the measurement signal S_{R} adjusts to a new level after the change and accordingly the arising difference values again become smaller, the processed measurement signal S₂ still approaches the new level relatively slowly.

FIG. 9A shows, again, the unprocessed measurement signal S_{R} shown in FIG. 7A. The processed measurement signal S₃ shown in FIGS. 9A and 9B was processes with a recursive filter of first order, as such is shown in FIG. 4. In such case, especially the parameter explained with reference to FIGS. 4 and 6 can be used. As evident based on FIGS. 9A and 9B, this form of embodiment yields still better results than in the form of embodiment explained with reference to FIGS. 8A and 8B. Especially, in the region, in which the measurement signal S_{R} adjusts to a new level after the change and accordingly the arising difference values again become smaller, the processed measurement signal S₃ approaches the new level almost without any time delay.

FIG. 10 shows the development D_{K} of the value for the recursion coefficients K, as they result in the case of application of the filter of the invention according to the form of embodiment (as such was explained in reference to FIGS. 9A and 9B) to the measurement signal S_{R} in the region of the change of the measurement signal S_{R}. In such case, it is evident that the value of the recursion coefficient K rises rapidly and strongly in the case of occurrence of a change in the measurement signal S_{R}. This means that the filter strength and therewith the smoothing of the measurement signal S_{R} are reduced rapidly and strongly. Additionally, it is evident based on FIG. 10 that the recursion coefficient K falls only slowly after the strong rise. As explained above, it is achieved therewith that the filter strength remains reduced longer and, therewith, the processed measurement signal S₃ can adjust rapidly to the changed level of the measurement signal S_{R}. For comparison, FIG. 10 shows additionally the development D_{KLIN} of the function values of the function Kₗᵢₙ(da), as they result in the case of application of the filter of the invention (according to the form of embodiment as explained in reference to FIGS. 9A and 9B) to the measurement signal S_{R} in the region of the change of the measurement signal S_{R}. In such case, it is evident that the function values of the function Kₗᵢₙ(da) in the presence of the rise (as was above explained) are identical; then, however, they decrease faster. In such case, it is to be taken into consideration that, due to the recursive structure, the illustrated curve of the function values of the function Kₗᵢₙ(da) deviate from the curve that would result in the case of the form of embodiment explained with reference to FIGS. 8A and 8B.

The upper diagram of FIG. 11 shows a phase difference, measurement signal of a Coriolis, flow measuring device changing periodically with a nominal amplitude and a certain frequency (here: 5 Hz with a data rate of 50 Hz), which was not yet processed according to the method of the invention and which forms a time discrete, one dimensional, measurement signal. The nominal amplitude is, in such case, greater than the expected noise level. In the lower diagram of FIG. 11 is shown a measurement signal processed according to the form of embodiment of the method of the invention explained with reference to FIGS. 9A and 9B. As evident based on FIG. 11, very good results are achieved with the method of the invention also in the case of changes in the measurement signal arising periodically with a certain frequency. Especially, the processed measurement signal follows (with a time delay of one sample, or of one sample value) exactly the unprocessed measurement signal. In the two diagrams of FIG. 11, again, along the x-axis, in each case, are plotted the sample value number or, generally, the measured value number of the sequence and, along the y-axis, the phase difference (unit: rad, or radians).

1-12. (canceled)

13. A method for processing a time discrete, one dimensional, measurement signal, which has a sequence of measured values (x(n)) following one after another in time, comprising steps as follows:
applying to the sequence a recursive filter with a variable recursion coefficient (K(n)), wherein the recursive filter is embodied in such a manner that, in each case, the output, measured value (y(n)) obtained for a measured value (x(n)) is obtainable by subtracting a preceding output, measured value (y(n−1)) from such measured value (x(n)), by multiplying the obtained difference value (d(n)) with a recursion coefficient (K(n)) associated with such measured value (x(n)) and by adding the obtained product to the preceding output, measured value (y(n−1));
in each case, for determining the recursion coefficient (K(n)) associated with a measured value (x(n)), a predetermined function (Kₗᵢₙ(da)) rising at least sectionally with the magnitude of the difference value (da) is applied to the magnitude (da(n)) of the difference value (d(n)) obtained for such measured value (x(n)); and
the obtained function value (Kₗᵢₙ(n)) is applied as recursion coefficient (K(n)) corresponding to such measured value (x(n)), at least when the function value (Kₗᵢₙ(n)) is greater than or equal to the recursion coefficient associated with the preceding measured value (K(n−1)).

14. The method as claimed in claim 13, wherein:
the function (Kₗᵢₙ(da)) has a step in such a manner that it rises more strongly after a first limit value (nthr) of the magnitude of the difference value (da) than in the region before the first limit value (nthr).

15. The method as claimed in claim 14, wherein:
the slope of the function (Kₗᵢₙ(da)) after a second limit value (nthr+nmrg) of the magnitude of the difference value (da), which is greater than the first limit value (nthr), is reduced relative to the slope in the region before the second limit value (nthr+nmrg).

16. The method as claimed in claim 13, wherein:
in each case, for determining the recursion coefficient K(n) associated with a measured value (x(n)), when the function value (Kₗᵢₙ(n)) obtained in reference to such measured value (x(n)) is less than the recursion coefficient associated with the preceding measured value (K(n−1)), the recursion coefficient K(n) associated with such measured value (x(n)) is determined according to a predetermined algorithm in such a manner that it is greater than the function value (Kₗᵢₙ(n)) and less than or equal to the recursion coefficient associated with the preceding measured value K(n−1).

17. The method as claimed in claim 16, wherein:
the predetermined algorithm is embodied in such a manner that the recursion coefficient (K(n)) associated with such measured value (x(n)) is obtainable by subtracting the function value (Kₗᵢₙ(n)) from the recursion coefficient associated with the preceding measured value (K(n−1)), by multiplying the obtained recursion coefficient difference values with a tuning factor (a) and by adding the obtained recursion coefficient product to the function value (Kₗᵢₙ(n)).

18. The method as claimed in claim 17, wherein:
the tuning factor (a) is greater than zero and less than or equal to one, especially that it lies in the range between 0.7 and 1.

19. The method as claimed in claim 14, wherein:
the function values (kl) of the function (Kₗᵢₙ(da)) in the region before the first limit value (nthr) are constant and greater than zero, especially constant and at least 64/8192.

20. The method as claimed in claim 15, wherein:
the function values of the function (Kₗᵢₙ(da)) in the region after the second limit value (nthr+nmrg) are constant and greater than the function value (kl) in the region before the first limit value (nthr), especially constant and 1.

21. The method as claimed in claim 15, wherein:
the distance (nmrg) between the first (nthr) and the second limit value (nthr+nmrg) lies in the range from 0.2 to 0.3 times the first limit value (nthr).

22. The method as claimed in claim 13, wherein:
the method is performed in a flow measuring device, with which at least one parameter of a fluid flowing in a pipeline is determinable, on a measurement signal (Δφ(tᵢ)) processed in the flow measuring device.

23. The method as claimed in claim 22, wherein:
the measurement signal is a phase difference, measurement signal (Δφ(tᵢ)) processed in a Coriolis, flow measuring device; and
wherein the phase difference, measurement signal (Δφ(tᵢ)) represents the phase difference of the oscillation at least one measuring tube (A, B) between two measurement points spaced on the measuring tube (A, B) in the flow direction.

24. A Coriolis, flow measuring device, which is insertable into a pipeline and by which a mass flow of a fluid flowing in the pipeline is determinable, wherein the Coriolis, flow measuring device, comprises:
at least one measuring tube for conveying fluid flowing in the pipeline;
at least one exciter, by which said at least one measuring tube is excitable to execute mechanical oscillations; and
two sensors provided on said measuring tube and arranged spaced from one another along the flow direction for registering mechanical oscillations of said measuring tube; wherein:
electronics of the Coriolis, flow measuring device is embodied in such a manner that said electronics can provide from sensor measurement signals produced by said two sensors time discrete, one dimensional, measurement signal (Δφ(tᵢ)), by which a phase difference of the oscillation of said measuring tube between the two measurement points said sensors is represented and which has a sequence of measured values following one after another in time;
that the electronics can apply to the sequence a recursive filter having a variable recursion coefficient (K(n));
said recursive filter is embodied in such a manner that, in each case, an output, measured value (y(n)) obtained for a measured value (x(n)) is obtainable by subtracting a preceding output, measured value (y(n−1)) from such measured value (x(n)), by multiplying the obtained difference value (d(n)) with a recursion coefficient (K(n)) associated with such measured value (x(n)) and by adding the obtained product to the preceding output, measured value (y(n−1));
that the electronics, in each case, for determining the recursion coefficient (K(n)) associated with a measured value (x(n)), can apply to the magnitude (da(n)) of the difference value (d(n)) obtained for such measured value x(n) a predetermined function (Kₗᵢₙ(da)) rising, at least sectionally, with the magnitude of the difference value (da); and
the obtained function value (Kₗᵢₙ(n)) is applied as recursion coefficient (K(n)) corresponding to such measured value x(n), at least when the function value (Kₗᵢₙ(n)) is greater than or equal to the recursion coefficient associated with the preceding measured value (K(n−1)).
